(19) United States
(12) Patent Application Publication
(10) Pub. No.: US 2002/0121624 A1
(43) Pub. Date: Sep. 5, 2002

(54) Flowing exothermic composition, heater element using the same and process for manufacturing the same

(76) Inventor: Akio Usui, Tochigi-shi (JP)

Correspondence Address: JORDAN AND HAMBURG LLP, 122 EAST 42ND STREET, SUITE 4000, NEW YORK, NY, 10168, US

(21) Appl. No.: 10/087,480

(22) Filed: Mar. 1, 2002

(30) Foreign Application Priority Data
Mar. 1, 2001 (JP) 2001-56873
May 21, 2001 (JP) 2001-150624

(51) Int. Cl. C09K 5/00; F25D 1/00

(52) U.S. Cl. 252/67

(57) ABSTRACT

In an exothermic composition for forming a heater element by lamination and encapsulation in a packaging material, when this exothermic composition has the plastic flowability and is controlled by the flowability, the loss of an exothermic material at manufacturing can be prevented, and a heater element having the better handling property and an arbitrary shape can be simply manufactured. Moreover, an exothermic composition can be distributed and maintained in a packaging material at an uniform thickness without imparting excess load on an extruding pump or the like of a coater. In particular, by adopting such the essential features that the aforementioned exothermic composition is laminated and encapsulated in the aforementioned packaging material and, a barrier moisture in the exothermic composition is moved to a water-absorbing sheet, continuous voids are formed in the interior of the aforementioned exothermic composition, and complex temperature control becomes possible. An object of the invention is to provide such the extremely useful flowing exothermic composition, to provide a heater element using the same (flowing exothermic composition), and to provide a process for manufacturing the same (heater element).

The present invention is an exothermic composition for forming a heater element by lamination and encapsulation in a packaging material, this exothermic composition having the plastic flowability, said composition being a flowing exothermic composition which is controlled by the flowability, a heater element using the same and a process for manufacturing the same.

### BACKGROUND OF THE INVENTION

1. Field of the Invention

The present invention relates to a flowing exothermic composition for forming a heater element by lamination and encapsulation in a packaging material, a heater element using the same and a process for manufacturing the same, more particularly, to a flowing exothermic composition which has the extremely better handling properties upon manufacturing, and can manufacture simply a heater element having an arbitrary shape and, moreover, can be distributed and maintained in a packaging material at an uniform thickness, in particular, by which prevention of the loss of an exothermic material at manufacturing and complicated control of a material become possible by such the construction that a moisture in the flowing exothermic composition as a barrier is moved to a packaging material and/or a water-absorbing sheet provided in the packaging material after manufacturing, whereby continuous voids are formed in the interior of the flowing exothermic composition, a heater element using the same and a process for manufacturing the same.

2. Prior Art

Recently, as a so-called disposable body warmer, a heater element has been widely spread and utilized in which a powdery exothermic composition is encapsulated in a flat packaging material comprising a film-like or sheet-like substrate having the breathability or non-breathability and a film-like or sheet-like covering material having the breathability.

Like this, when an exothermic composition is formed in powders, a powdery exothermic composition is incorporated in the most suitable state where an exothermic reaction, that is, an oxidizing reaction easily occurs and furthermore, the composition is powdery and porous, thereby having a great surface area and extremely better contact with air. Therefore, when formulated into a heat element, the exothermic reaction is approximately determined by a breathing amount of a packaging material.

Therefore, at manufacturing, during incorporation of an exothermic composition at an appropriate incorporating ratio, or during from manufacturing of an exothermic composition to encapsulation of the resulting heater element into a non-breathable packaging material, an oxidizing reaction with air, that is, an exothermic reaction occurs, and the loss of an exothermic material in an exothermic composition occurs and, at the same time, the quality of an exothermic composition is deteriorated. Thus, there is a problem, in particular, in manufacturing a thin sheet-like heater element.

In addition, since an application-type thin (sheet-like) heater element which is most popular currently is obtained by filling a powdery exothermic composition into a packaging material which is converted into sheet-like by rolling or the like, a variance in a thickness is produced at a manufacturing step and, thus, a heater element can not be formed into an uniform sheet. Further, there was such a problem that an exothermic composition is moved in a packaging material even at transport or use, a sense of incongruity is caused due to the irregularity, a variance in a temperature distribution is caused and skin disorder such as burn at a lower temperature is caused.

In addition, for maintaining a heater element thin (sheet-like), as a material, a porous film for which it is difficult to make a specification width of the breathability smaller must be used and, therefore, a variance in an exothermic temperature of a heater element as a final product becomes problematic.

Then, in order to solve such the various problems, the present inventors intensively studied a heater element in which an exothermic reaction of an exothermic composition is surpressed to prevent the loss of an exothermic composition by an exothermic reaction at manufacturing, deterioration of the quality of an exothermic composition and a variety of bad effects associated with coagulation of an exothermic composition, an ultra-thin exothermic heater can be manufactured rapidly and, furthermore, movement and bias of the exothermic composition are prevented by dispersing and fixing an exothermic composition uniformly in a packaging material and, moreover, an excess exothermic reaction of an exothermic composition is avoided as much as possible.

As a result, the present inventors found that, by using “viscous exothermic composition”, that is, an exothermic composition, with the viscous property controlled by the viscosity, in place of a powdery exothermic composition, lamination can be extremely easily performed on a film-like or sheet-like substrate by screen printing, gravure printing or coating, and an ultra-thin heater element can be manufactured rapidly and, further, a lamination amount per unit area upon lamination of an exothermic composition in a packaging material can be dispersed accurately and uniformly and, moreover, in this viscous exothermic composition, a moisture therein or a moisture in a gel containing free water or water becomes an air blocking layer (hereinafter, referred to as a barrier moisture) and, for this reason, contact with air is remarkably small as compared with a powdery exothermic composition and, accordingly, an exothermic reaction in a manufacturing step can be stopped, and the loss of an exothermic material such as metal powder can be made smaller, which was already filed as a patent application (Japanese Unexamined Patent Publication No. 9-75388).

However, there is a problem that, although this viscous exothermic composition has such the excellent advantages, voids for supplying air into the interior of an exothermic composition are incompletely formed after movement of a moisture in an exothermic composition to a water-absorbing layer depending upon a kind and an amount of a water-absorbing polymer and/or a thickening agent and an amount of a moisture, supply of air becomes insufficient, and an exothermic efficacy is lowered.

Then, the present inventors found that, by incorporating an aggregate particle in this viscous exothermic composition, this aggregate particle prevents a volumetric change accompanied with an exothermic reaction, gradually enlarges and forms a path for air supply to make contact of an exothermic composition in the interior of a heater element with air extremely better, and an exothermic reaction continues over a long period of time, which was already filed as a patent application (Japanese Unexamined Patent Publication No. 10-192329).

However, in the case where a heater element is prepared using the “viscous exothermic composition” disclosed in Japanese Unexamined Patent Publication No. 9-75388 or Japanese Unexamined Patent Publication No. 10-192329, when the exothermic composition is supplied to a head or a coater to extrude on a substrate through a head at a lamination step at manufacturing, a variance is quantitatively caused depending upon a kind and an amount of an aggregate, a moisture is flown out or segregated from the exothermic composition and, thus, a mixing ratio becomes nonuniform, resulting in a variance in the performance, a great load is burdened on a pump and, thus, the heat is produced from a motor and a motor is stopped, leading to many reported problems.

Although this problem was considered to be due to the “viscous property” of an exothermic composition, even in a heater element having the same viscous value (viscosity), this problem occurs in some cases and does not occur in some cases. The cause therefor has not been elucidated until now.

Then, the present inventors studied and investigated the cause of generating this problem, and confirmed that this problem is not resulted from the “viscous property” of an exothermic composition but is greatly resulted from the “flowability” of an exothermic composition.

That is, when the flowability of an exothermic composition is worse, a great force becomes necessary when the exothermic composition is supplied to a head or a coater and extruded into a sheet through a head. For this reason, a load is burdened on an extrusion motor, and the motor produces the heat or is stopped and, further, a moisture is squeezed out from the exothermic composition and, as a result, a variance is produced in the quantitation, affecting on the heat producing capability of the manufactured heater element.

However, until now, this flowability has been considered to be proportionate to the viscous property of an exothermic composition or have the same meaning as that of the viscous property. Thus, it has been recognized that an exothermic composition having the viscous property has the flowability and, therefore, as far as the viscous property is controlled, the flowability becomes a corresponding value.

However, the present inventors tested and studied some exothermic compositions regarding this point, and obtained the findings that the aforementioned consideration is totally incorrect, that is, the viscous property and the flowability are different, when the viscous property is low, the flowability is not necessarily better and, conversely, even when the viscous property is high, the flowability is better in some cases and, thus, the flowability of an exothermic composition can not be controlled by controlling of the viscous property.

Then, the present inventors obtained the findings that, by controlling an exothermic composition by the flowability, the aforementioned problem is solved, the techniques such as printing technique and coating can be utilized at a manufacturing step, and quantitation (weighing) can be performed very simply and accurately and, thus, the quality of a heater element can be improved.

In addition, we obtained such the findings that, by controlling an exothermic composition by the flowability, the exothermic composition can be pipe-transported by a pump or the like, and can be directly laminated on a packaging material without contact with air from a raw material tank to a laminating step.

Further, we obtained the findings that an exothermic composition with this flowability controlled has a large amount of a moisture, such the moisture becomes a barrier moisture against air and prevents contact of exothermic composition with air and, therefore, there is no loss of an exothermic material due to heat production at manufacturing, and deterioration of the quality can be prevented.

In addition, we obtained the findings that, by constructing the exothermic composition with this flowability controlled such that, after lamination and encapsulation in a packaging material, a barrier moisture in the exothermic composition is moved to a water-absorbing sheet, continuous voids are formed in the interior of the exothermic composition and, as a result, an exothermic reaction in the interior of the exothermic composition becomes smooth.

However, we obtained also the findings that, when an exothermic composition has the low flowability, there is a problem that the composition is elongated or cut upon lamination on a stretchable packaging material or a water-absorbing sheet having the weak strength, but when an exothermic composition has the high flowability, it can be laminated uniformly with a small pressure and, thus, these problems can be avoided.

We also obtained the findings that since the flowability is generally lowered when an aggregate is incorporated, it is necessary to increase a thickening agent or moisture, but when such the essential features are adopted, the exothermic reactivity is decreased, leading to no resolution of a problem.

Then, an aggregate has been sought which does not decrease the flowability without any increase in an amount of a thickening agent or moisture even when the aggregate is incorporated. We also obtained the findings that, by incorporation of a hydrophobic aggregate, a moisture in an exothermic composition is moved more rapidly, continuous voids are formed in the interior of an exothermic composition in a short period of time, the exothermic reaction efficacy is remarkably improved and, further, oxidized iron powders can be prevented from binding and, as a result, the flexibility of a heater element is not lost during or after use and, thus, the flexibility and the use feeling can be improved.

The present invention was completed based on the aforementioned technical findings. That is, in an exothermic composition for forming a heater element by lamination and encapsulation in a packaging material, this exothermic composition has the plastic flowability and is controlled by the flowability, whereby the loss of an exothermic material is prevented at manufacturing, a heater element having the extremely better handling property and an arbitrary shape can be simply manufactured, and an exothermic composition can be distributed and maintained in a packaging material at an uniform thickness without burdening an excess load on an extruding pump of a coater. In particular, by adopting such the essential features that barrier moisture in the exothermic composition is moved to a water-absorbing sheet after lamination and encapsulation of the exothermic composition in the packaging material, continuous voids are formed in the exothermic composition, and complex temperature control becomes possible. An object of the present invention is to provide such the extremely useful flowing exothermic composition, provide a heater element using this (flowing exothermic composition), and provide a process for manufacturing that (heater element).

In order to attain the aforementioned object, the flowing exothermic composition of the present invention (hereinafter, referred to as “present composition”) is an exothermic composition for forming a heater element by lamination and encapsulation in a packaging material and is characterized in that this exothermic composition has the plastic ability and is controlled by the flowability.

The present composition will be explained in detail below.

The present composition has the characteristics that it is not the previous powdery exothermic composition but a flowing exothermic composition which has the plastic ability and is controlled by the flowabilitiy.

This present composition is not particularly limited but it comprises a component which reacts with oxygen in air to cause an exothermic reaction and manifests the flowing property.

Specifically, for example, the present composition can be obtained by adjusting a ratio of moisture or other components in various components constituting the present composition.

By the way, the present composition is an exothermic composition controlled by the flowability. At the present stage, it is preferable to control by measuring the flowability value by a measuring method using Texture Analyzer (manufactured by Stable Micro Systems, England, Model TX-XT21) described below. However, when other methods or apparatuses for measuring the flowability are established in the future and a constant correlation is obtained between the measured value and a measured value according to a measuring method using the aforementioned Texture Analyzer, it is naturally expected in the present technical idea that the flowability is measured using that method and is controlled.

The present composition has such the essential features and, as a result, various merits are generated as described below.

That is, since the present composition is an exothermic composition having the flowability, when the present composition is supplied to a head or a coater, pushed against a stencil or an intaglio and scraped with a doctor for cup weighing, it becomes possible to extrude rapidly with a small force and scrape an extra exothermic composition smoothly. For this reason, a load is hardly burdened on an extruding motor, and a motor does not produce the heat and not stopped. For example, the present composition can be extremely easily transferred and laminated on a substrate by application or coating using the known transferring or printing techniques such as transference, thick printing, gravure printing, offset printing, screen printing and spraying, or with a head coater, a roller, an applicator and the like. Moreover, an ultra-thin heater element can be manufactured rapidly, and the composition can be quantitated (weighed) very simply and accurately and, thus, the exothermic composition can be distributed uniformly in a packaging material.

In addition, by controlling an exothermic composition by the flowability, it becomes possible to pipe-transport the exothermic composition with a pump or the like, and the composition can be directly laminated on a packaging material without contact with air from a raw material tank to a laminating step.

Further, in an exothermic composition with this flowability controlled, an exothermic material is covered with a moisture, the moisture becomes a barrier moisture against air, and prevents contact of the exothermic composition with air and, therefore, there is no loss of an exothermic material due to heat production at manufacturing and, deterioration of the quality can be prevented.

Examples of the present composition include a composition containing an exothermic material, a carbon component and/or metal chloride and water as a component and having the flowability as a whole. In this case, a water-absorbing polymer and/or a thickening agent may be incorporated as necessary.

As an apparatus for mixing these components, conventional apparatuses may be used, but a kneading apparatus which can make components into the viscous material exhibiting the flowability in a short period of time is desirable since, when all components or components having a small amount of a moisture are mixed for a longer period of time in the powder state having great contact with air, the heat production is initiated, a moisture is evaporated and the flowability is changed. In order to extremely suppress the heat production, it is desirable to add an exothermic material after components other than an exothermic material are converted into the viscous material. Placement of an exothermic material at divided times is further desirable since the heat producing state can be shortened and a load of the apparatus becomes small.

The present composition is not particularly limited as long as an exothermic composition has the flowability and the desired temperature properties can be obtained. Specifically, it is preferable that 0.1-10 parts by weight of a water-absorbing polymer and/or 0.1-10 parts by weight of a thickening agent, 1.5-20 parts by weight of a carbon component and/or 1-15 parts by weight of a metal chloride are incorporated relative to 100 parts by weight of an exothermic material and, further, at least one of 0.5-10 parts by weight of an inorganic or organic water retaining agent and 0.1-5 parts of weight of a pH adjusting agent is incorporated relative to 100 parts by weight of an exothermic material. In particular, water is added to this mixture such that an exothermic composition has the flowability as a whole. In this case, a predetermined amount of a metal chloride may be dissolved or dispersed in water, which may be added to a mixture of a water-absorbing polymer and/or a thickening agent and a carbon component and/or a metal chloride so that the composition has the flowability as a whole.

As the water-absorbing polymer, there can be exemplified those described in Japanese Unexamined Patent Publication No. 10-155827. Examples thereof include KI Gel 201-K, and KI Gel 201-F2 manufactured by Kuraray Co., Ltd., and Sunfresh ST-500 MPS manufactured by Sanyo Chemical Industries, Ltd.

As the thickening agent, mainly, there are materials which absorb water or an aqueous solution of a metal chloride, and increase the viscosity, or impart thixotropy properties, for example, one kind of a mixture or two kinds selected from bentonite, activated clay, stearate, polyacrylate such as sodium polyacrylate and the like, gelatin, polyethylene oxide, polyvinyl alcohol, polyvinyl pyrrolidone, gum arabic, tragacanth gum, locust bean gum, guar gum, gum arabic, alginate such as sodium alginate and the like, pectin, carboxyvinyl polymer, dextrin, starch series water-absorbing agent such as gelatinized starch, processed starch and the like, polysaccharide series thickening agent such as carrageenan and agar, cellulose derivative series thickening agent such as CMC, ethyl acetate cellulose, hydroxyethylcellulose, methylcellulose and hydroxypropylcellulose, water-soluble cellulose ether, N-vinylacetamide, acrylic series emulsion and urethene emulsion. These thickening agents mainly absorb water or an aqueous solution of a metal chloride and increase the flowability.

As the aforementioned exothermic material, carbon component and metal chloride used in the present composition, there can be exemplified those described in Japanese Unexamined Patent Publication No. 10-155827.

In addition, as the aforementioned pH adjusting agent, there are normally used pH adjusting agents such as calcium hydroxide and the like.

The present composition is controlled by the flowability, and it is required that this flowing exothermic composition be a flowing exothermic composition exhibiting such the plastic flowability that deformation does not occur until a force is applied to a some extent, in view of uniform transference.

And, the present composition is controlled by the flowability as described above. The flowability may be appropriately selected depending upon a printing format and performances of a coating head or coater or an extruding pump. At the present stage, it is desirable that a measured value by a measuring method using the aforementioned Texture Analyzer (manufactured by Stable Micron Systems, England, Model TX-XT21) at a temperature of 20° C. is in a range of 0.5-20.0 kg/cm².

When the flowability of the present composition is too small as less than 0.5 kg/cm², a moisture becomes extremely excessive, the uniformity of components can not be maintained due to precipitation, a moisture is leaked through a head, and, when a thickening agent is excessive, the reactivity becomes worse, an amount of transference of other components becomes small, a heat producing time becomes short, the present composition is bled out the predetermined region on a substrate after transference, dripping easily occurs, and a large amount of a moisture is necessary to be absorbed in a substrate or the like after transference and, thus, it is necessary to use a substrate or the like having a special structure and make a structure of a heater element more complicated, being not preferable. On the other hand, when the flow ability exceeds 20 kg/cm², the flowability becomes too small, an extremely great force becomes necessarily upon supply of the present composition to a head or a coater and extrusion on a substrate through a head. For this reason, a load is burdened on an extruding motor, a motor produces the heat and is stopped and, furthermore, a moisture is squeezed from the present composition and, as a result, a variance is caused in quantitation, the exothermic capability of the manufactured heater element is also affected, and it becomes difficult to pipe-transport with a pump or the like, being not preferable.

Therefore, from these reasons, at a temperature of 20° C., in the case of screen printing, a flowability range of 1.0-10.0 kg/cm² is preferable, and a flowability range of 2.0-7.0 kg/cm² is particularly preferable.

The aforementioned measured value was measured by a tubing test using Texture Analyzer (manufactured by Stable Micro Systems (SMS), England, Model TX-XT2i).

Soft wear (Windows Version): SMS Texture Expert computer:PC300PL manufacture by IBM was used. A method of tubing test

About 200 g of a flowing exothermic composition was weighed into a cylinder with a balance, and the surface of the composition was made smooth to some extent with a spatula. Considering a variance in the packing state of the flowing exothermic composition and intervals in the flowing exothermic composition, a piston was first lowered manually from a cylinder upper part, a constant load (1 Kg) was applied, and a part of the flowing exothermic composition came out through a bottom hole of a cylinder. Thereafter, measurement was initiated, the piston was pushed down at a constant rate (1.0 mm/sec), and a load between 10.0 mm applied to the piston when the flowing exothermic composition came out through a bottom hole was measured with the aforementioned Texture Analyzer. As this value is smaller, the flowability is higher.

Shape of a cylinder; cylinder having an inner diameter of 50 mm having a circular hole of 10 mm opened on its bottom

A shape of a piston; a disk-like plate having an external diameter of 48 mm and a thickness of 5 mm

The conditions of measuring program for aforementioned Texture Analyzer (manufactured by Stable Micro Systems (SMS), England, Model TX-XT2i) were set as follows:

Test Type: Measure a load by compression.

Measure Type: Return to a start position.

Pre-test Speed: 1.0 mm/sec

Test Speed: 1.0 mm/sec

Post-test Speed: 10.0 mm/sec

Distance: 10.0 mm

Probe: tubing cell (Insert 10 mmΦ hole)

HDP/FE Platform: platform for tubing cell

Temperature: 20° C.

Trigger: Auto: 500 g

PPS: 200

Generally, in such the exothermic composition, the flowability immediately after kneading is the highest and, thereafter, the flowability is gradually becomes lower. However, the flowability value in the present composition is a value at transference and lamination.

Like this, in the present composition, since such the essential features are adopted that the constant flowability (and the viscosity) are harbored by adjusting an incorporation rate of a moisture in the exothermic composition and an amount of a water-absorbing polymer and/or a thickening agent, transference and lamination by printing or coating are extremely easy and an ultra-thin heater element can be manufactured rapidly without burdening an excess load on an extruding motor. Furthermore, a free moisture and a moisture in a water-containing gel becomes a barrier moisture forming a barrier layer, and an amount of air supply is decreased to substantially stop an exothermal reaction and, as a result, the composition is more stable in air, and such the merits are exhibited that the loss of an exothermic material due to an exothermic reaction at manufacturing, deterioration of the quality of an exothermic composition and coagulation of an exothermic composition are prevented more.

After manufacturing, when a part or all of the barrier moisture is absorbed in a water-absorbing sheet, a barrier layer is lost, and the state where an exothermic composition is compact and its surface area becomes smaller is converted into the state where an exothermic composition is porous and its surface area becomes larger and, as a result, contact with air becomes better.

By adopting such the essential features that continuous voids are formed in the interior of an exothermic composition, a heater element is obtained in which a volumetric change accompanied with an exothermic reaction is prevented, a path for supplying air is gradually spread and formed to make contact of an exothermic material in the interior with air extremely better, an exothermic reaction in the interior of exothermic composition becomes smooth, an exothermic reaction continues for a long period of time, and the exothermic properties are better.

As a method of forming continuous voids in the interior of this exothermic composition, it is preferable that, for example, a void-forming fiber is incorporated into an exothermic composition, and an exothermic composition is laminated and encapsulated in a packaging material and, thereafter, a barrier moisture in the exothermic composition is moved to a water-absorbing sheet, whereby, continuous voids are formed in the interior of the aforementioned exothermic composition.

As this void-forming fiber, aggregate particles such as those disclosed in Japanese Unexamined Patent Publication No. 10-192329, for example, activated clay, pearlite, silica-alumina powder, silica-magnesia powder, calcinated magnesia, kaolin, pumice, zeolite, magnesia powder, precipitated alumina gel, active alumina, calcium carbonate, silica gel, cristobalite, vermiculite, silica series porous material, silicate such as calcium silicate, pebble such as silica stone, diatomaceous earth, alumina and the like, pebble silicate such as mica powder, clay and the like, magnesia silicate such as talc and the like, silica powder, activated carbon, charcoal, organic and/or inorganic short fiber, wood flour, pulp powder and the like may be also used.

However, aggregate particles disclosed in Japanese Unexamined Patent Publication No. 10-192329 are preferably particles having the water absorption properties and/or water retention properties or organic and/or inorganic short fibers.

Aggregate particles having the water absorption properties and/or water retention properties are considered to be preferable in Japanese Unexamined Patent Publication No. 10-192329 because aggregate particles having the water absorption properties and/or water retention properties retain water or salt water in an exothermic composition and, when a moisture in an exothermic composition becomes insufficient accompanied with an exothermic reaction, exhausted water or salt water is released from aggregate particles, being preferable.

Above all, as aggregate particles in Japanese Unexamined Patent Publication No. 10-192329, porous particles are preferable because, when a moisture is decreased by an exothermic reaction, porous aggregate particles themselves are expected to have both roles as moisture supply and an air supply path.

However, aggregate particles in Japanese Unexamined Patent Publication No. 10-192329 are not selected by considering the flowability of an exothermic composition. When such the aggregate particles having the water absorption properties are used in the present invention, the aggregate particles absorb moisture in an exothermic composition, the flowability of an exothermic composition, and control of the flowability becomes difficult. For this reason, it becomes necessary to increase an amount of moisture to be incorporated and, as a result, a problem arises that initial heat production becomes delayed.

Although this problem can be solved by using a packaging material and/or a water-absorbing sheet having the high water absorption properties, such the use increases the cost and generates a cause of having adverse effects on the flexibility and the sealing strength.

In the present composition, it is preferable that, as a void-forming fiber for forming continuous voids in the interior of an exothermic composition, a hydrophobic void-forming fiber is used.

That is, by using a hydrophobic void-forming fiber as a void-forming fiber, the better flowability is maintained without absorption of moisture in an exothermic composition by a void-forming fiber at manufacturing. On the other hand, after lamination and encapsulation in a packaging material, a barrier moisture in an exothermic composition is rapidly released and, at the same time, a void-forming fiber captures iron powder or activated carbon and forms a so-called three dimensional network structure, forming continuous voids.

In this case, it is confirmed that a moisture necessary for an exothermic reaction is held in both an exothermic composition layer and a packaging material and/or a water-absorbing sheet, and a sufficient amount of a moisture is successively supplied accompanied by an exothermic reaction. This excludes the necessity to increase an amount of moisture in an exothermic composition, and such a problem does not arise that initial heat production is delayed and moisture containing iron ions is bled out.

In the present composition, an amount of a void-forming fiber to be incorporated, and a length and a thickness (diameter) of a fiber are not particularly limited but are appropriately selected depending upon the properties required for an exothermic composition. A general amount of a void-forming fiber to be incorporated is in a range of 0.1-20% by weight, preferably in a range of 1-10% by weight based on a total weight of the aforementioned exothermic composition. As a fiber length of a void-forming fiber, 3 mm or shorter is preferable, in particular, 2 mm or shorter is more preferable, 0.005-1.5 mm is further preferable. Further, as a thickness (diameter) of a fiber, a smaller thickness, that is, 500 micron or smaller is preferable, 200 micron or smaller is more preferable, 100 micron or smaller is more preferable, in particular, 0.005-50 micron is particularly preferable.

When an amount of a void-forming fiber to be incorporated is less than 0.1% by weight relative to a total weight of the present composition, the amount is too small and an air supply path is sufficiently formed, leading to possible worse contact of an exothermic material in an exothermic composition with air. On the other hand, when the amount exceeds 20% by weight, an absolute amount of an exothermic material is lacked, the flowability of an exothermic composition is affected, and maintenance of a required heat production time becomes difficult, being not preferable.

A void-forming fiber used in the present composition may be used by appropriate selection depending upon the properties required for an exothermic composition. Examples thereof are not limited to but include synthetic fibers such as a polyamide series fiber, polyester series synthetic fiber, polyvinyl alcohol series synthetic fiber, an acrylic series synthetic fiber, a methacrylic series synthetic fiber, a polyolefin series synthetic fiber and the like, as well as inorganic fibers such as a glass fiber, a carbon fiber and the like.

Above all, as a void-forming fiber in the present method, a multi-branched polyolefin series synthetic fiber is most preferable from a viewpoint of the hydrophobicity, the dripping prevention, the viscosity increasing effect, the stabilized flowability, the void-forming properties and the component separation prevention.

Examples of commercially available multi-branched polyolefin series synthetic fiber include Chemibest Series FD990, FD780, FD380, FDSS-2 and FDSS-5 manufactured by Mitsui Chemicals, Inc.

Then, a heater element using the aforementioned present composition (hereinafter, referred to as “present heater element”) will be explained in detail but a part overlapping with items described in the explanation of the present composition will be omitted for avoiding the repetition.

The present heater element is characterized in that the present composition is laminated and encapsulated in a sheet-like packaging material, at least a part of which has the breathability.

Here, in order to promote an exothermic reaction smoothly in the present heater element, it is necessary to move moisture as a barrier from an exothermic composition layer to a packaging material. Usually, it is necessary that a packaging material, that is, at least one of a substrate and a covering material has the water absorption properties.

However, in the case where at least one of a substrate and a covering material has the water absorption properties like this, there is a problem that, as a result of the insufficient heat sealing properties of this kind of packaging material, heat sealing of a sealing part at a circumferential part of a packaging material can not be performed.

For this reason, in the case where a circumferential part of a packaging material is sealed, it is necessary to seal via an adhesive such as a hot melt or a pressure-sensitive adhering agent.

However, although a circumferential part of a heater element is adhered with a hot melt or the like in this way, there is a risk that the sealing strength is decreased and pealing occurs accompanied with rise in a temperature. In addition, since a water-absorbing substrate or a covering material is hydrophilic and the sealing is incomplete and, thus, the sealing strength can not be obtained, there is a problem that clothes and skins are stained by blur or bleeding out of iron ions, and there is a fatal problem that, since a substrate and/or a covering material absorb a moisture in the present composition, the sealing strength is more decreased and a sealing part is peeled.

In particular, when one wants to prolong an enduring time of a heater element, a laminated thickness of the present composition must be larger, and an amount of water absorption of a water-absorbing substrate and/or a covering material must be increased in proportionate therewith and, as a result, it is necessary to make a water-absorbing layer thicker. However, there is a problem in a packaging material that, when a water-absorbing material and/or a covering material are made thicker, the sealing performance (heat-sealing properties and thermal adhesion property) of a sealing part becomes extremely worse.

However, although an amount of tailings after punching of a substrate or a covering material in the case where a shape of a heater element is square, an amount of tailings after punching of a substrate or a covering material becomes large in the case of an irregular-shaped heater element, and its recycling becomes problematic.

In particular, recently, from a viewpoint of efficient utilization of resources, decrease in trash, and prevention of environmental destruction, recycle of tailings after punching of a substrate or a covering material is strongly required in society.

However, even when at least one of a substrate or a covering material has the water absorption properties, tailings after punching become a composite layer of a polyethylene layer, a paper (water-absorbing) layer and a non-woven layer. For this reason, it is difficult to peal them into pieces, tailings after punching of a water-absorbing packaging material, that is, a water-absorbing substrate and/or a covering material can not be recycled, leading to increase in an amount of industrial waste. Thus, improvement of this is desired.

In addition, transport of a packaging material from a base paper maker to a processing place for conjugating the material, as well as a step of application, a step of slitting, a step of packaging, and transport at the processing place are necessary, causing the high price.

Further, since the flexibility as a heater element is lost when a substrate and/or a covering material are formulated into a multi-layer and, in the case of a plural layered packing material such as hydrophobic layer/polyethylene layer/hydrophilic (water-absorbing) layer, materials constituting respective layers have different elongation rates at water absorption, there is a problem that a moisture in the present composition is absorbed, warpage is produced, troubles during a step happen, and the merchandise value is deteriorated.

As a method for solving these problems, there is provided a heater element in which a viscous exothermic composition is present between a substrate and a covering material and in which a powdery pulp is laminated on one side or both sides of the exothermic composition (Japanese Unexamined Patent Publication No. 10-155827).

In this case, a mixture of air and a powdery pulp is sucked with a blower, the mixture is passed through a predetermined region of a substrate so as to filter a powdery pulp in the mixture and the powdery pulp is laminated. According to this method, an excellent heater element is obtained. However, a noise resulting from the blower is great, dusts of a powdery pulp are flied in a working place, leading to deterioration of the working environment. Further, since a large-scale apparatus is necessary, a heater element becomes high price. Moreover, alteration in a shape needs a much cost. And, in a mixture of air and a powdery pulp, the air passes through an easily permeable site of a substrate, that is, a site having a small resistance, and a powdery pulp is laminated on that site and, as a result, there is a possibility that a variance is caused when a laminated thickness is 100 g/m² or smaller.

Then, in the present heater element, it is preferable that, upon removal of barrier moisture of an exothermic composition, not a water-absorbing layer comprising a powdery pulp but a water-absorbing sheet is used. That is, by covering one side or both sides of the present composition with a breathable water-absorbing sheet, the water-absorbing sheet manifests the stable water absorbing properties, the productivity is better, and a barrier moisture of the present composition is rapidly removed, leading to a porous exothermic composition. Thereby, the aforementioned problems can be solved at once.

In particular, by adopting such the essential features that the aforementioned water-absorbing sheet is laminated so as to cover one side or both sides of the present composition, and so as not to be present at a sealing part, the sealing strength of a sealing part is much improved, being preferable.

The present heater element adopts such the essential features and, as a result, a variety of merits are produced as described below.

That is, in the present heater element, the aforementioned water-absorbing sheet is provided so as to cover the present composition except for a part for sealing a substrate and a covering material, whereby complete heat sealing between a covering material with a hydrophobic and heat-fusion bonding and a substrate becomes possible. In addition, a water-absorbing sheet absorbs moisture in the present composition to remove a barrier layer, whereby, rise in a temperature at initiation of use can be heightened rapidly.

In addition, in the present heater element, since the element is a thin-type sheet-like heater element, the soft feeling is much improved by a water-absorbing sheet, the element is rich in the flexibility, a heat producing temperature is stable and excess heating can be prevented and, thus, the safety is extremely improved. In particular, in any shape, the loss of an exothermic composition is not present and, additionally, a packaging material (substrate, covering material) and a water-absorbing sheet are a separate member and, therefore, a multi-layer of a packaging material is extremely avoided and single layered parts are many, and the low cost and recycle of tailings after punching can be performed. Therefore, such a structure is adopted that separation and segregation can be easily performed after punching tailings and recycle becomes possible, and the flexibility can be increased. Moreover, defects that an initial heat producing rate is slow, and iron ions do not bleed out a sealing part, which are defects of a heater element in which the present composition is laminated and encapsulated in a packaging material having the breathability, are solved.

Further, in the present heater element, when a lamination pattern for the present composition is divided small, and a plurality of them are combined, grouped and unified to laminate one water-absorbing sheet, a part on which no exothermic composition is laminated is easily bent and, therefore, the flexibility of a heater element is remarkably improved.

In addition, by providing a water-absorbing sheet having the great adiabatic properties at an outside, release of the heat towards an upper side (outside) can be extremely prevented, and an effective heater element which hardly receives effects of an outer temperature is obtained.

As a sheet-like packaging material used in the present heater element materials formed of a film-like or sheet-like substrate and covering material are preferable, in which at least one of them or a part of them has the breathability, and the substrate and covering material have the heat-fusion bonding (heat-sealing properties) or the heat adhesion property. In particular, in order to enhance the sealing strength of a sealing part and the sealing property at a sealing part, it is preferable that a sealing layer is hydrophobic, and a covering material and a substrate having the heat fusion property are used. Specifically, packaging materials are not particularly limited as long as they are used in the previous disposable body warmer field. In addition, in a packaging material, as long as a substrate and a covering material can thermally fused or thermally adhered mutually, the same or different kinds of them can be used. Like this, when a packaging material is used in which a substrate and a covering material have the heat fusion property or the heat adhesion property, in particular, the heat fusion property, both are bonded firm and, as a result, layers are not pealed and the reliance is remarkably improved.

A water-absorbing sheet used in the present heater element is not particularly limited as long as it has the water absorption properties and, when contacted with the aforementioned viscous exothermic composition, absorbs a part of the moisture. Specifically, examples thereof include papers such as a recycled paper, a paper, a board, a coated board, a liner paper and pulp non-woven cloth, water-absorbing expandable films and sheets (foams such as water-absorbing expandable polyurethane), and non-woven, woven or knitted cloths formed of a hydrophilic fiber such as rayon and cotton. Among them, when the water absorption properties, the functionality and the economical properties are taken precedence of, it is preferable that a paper, a board or a liner paper is used. In addition, when the soft feeling of the resulting heater element is required, a non-woven cloth having a great void rate is used, or a hydrophobic non-woven cloth having the cushion properties is laminated between a substrate or a covering material and the aforementioned water-absorbing sheet. When these materials are used by applying to the interior of underwear, the extremely better results such as remarkably excellent use feeling and prevention of burn at a low temperature are obtained.

In the present heater element, a water-absorbing sheet may be formed by inclusion of a water-absorbing agent in a support (non-woven cloth such as polyester) having no water-absorbing properties. In particular, a polymer sheet in which a water-absorbing sheet is formed by inclusion of a water-absorbing agent in a water-absorbing support is preferable because it can be thinned due to increased water absorption rate. Examples of this water-absorbing support include the aforementioned water-absorbing sheets, that is, papers, water-absorbing expandable films and sheets, non-woven cloths, woven cloths and knitted cloths.

Examples of the aforementioned water-absorbing agent include the aforementioned water-absorbing polymers and thickening agents, or the no water-absorbing powders and silica gel.

A method of inclusion of a water-absorbing agent in a sheet-like water-absorbing support in the present heater element is not particularly limited but includes methods of impregnation, inclusion, applying (coating), transference, built-in and spraying of water-absorbing agent in the water-absorbing support. In this case, a rate of a water-absorbing agent to be incorporated may be determined arbitrarily. Generally, a ratio of inclusion of a sheet-like water-absorbing support and that of a water-absorbing agent is desirably in a range of 5-75 parts by weight relative to 100 parts by weight of the water-absorbing because the flexibility, the water absorption properties, the stability, the elasticity, the soft feeling and the feeling are better, and the use feeling is excellent.

As the aforementioned water-absorbing sheet, sheets having a basis weight of 15-500 g/m²and a water-absorbing amount of two or more times own weight, preferably a basis weight of 25-250 g/m² and a water-absorbing amount of 5 or more times own weight are desirable.

By the way, in the present heater element, a lamination thickness of a laminated exothermic composition is different depending upon the heat production amount and, when a lamination thickness of the exothermic composition is great, a high water-absorbing amount is necessary. In this case, it is preferable to use a water-absorbing sheet formed by inclusion of a water-absorbing agent in a sheet-like absorbing support.

As a preferable aspect of a water-absorbing sheet formed by inclusion of a water-absorbing agent in this water-absorbing support, there is a water-absorbing sheet having a three layered structure of a paper/a water-absorbing polymer/a paper, more suitably a water-absorbing sheet having a construction of a paper 18 (g/m²)/a water-absorbing polymer (12 g/m²)/a paper 18 (g/m²). As the breathability of a water-absorbing sheet, a great breathing amount is desirable, generally, a range of 50 seconds or shorter/100 ml is desirable, in particular, 1 second/100 ml second or smaller is preferable in order to fasten initial heat production.

In the present heater element, depending upon use, it is preferable that an adhesive layer is formed on at least a part of an exposed side of any one of a substrate and a covering material, at an arbitrary time point until encapsulation in an air-tight outer packaging material.

Then, a process for manufacturing the present heater element (hereinafter, referred to as “present process”) will be explained in detail.

The present process comprises patterning and laminating a flowing exothermic composition (present composition) on a sheet-like water-absorbing sheet having the breathability, laminating another water-absorbing sheet thereon so as to cover the exothermic composition, fixing respective water-absorbing sheets with an adhesive force of the exothermic composition in the state where the aforementioned exothermic composition is held therebetween, removing a sealing part, punching out into a greater shape than that of an exothermic composition to form a laminate and, then, holding this laminate between a substrate and a covering material to thermally fuse or thermally adhere a part for sealing the covering material and substrate.

That is, in the present process, first, a step (A) of patterning and laminating a flowing exothermic composition on a sheet-like water-absorbing sheet having the breathability, and a step (B) of laminating another water-absorbing sheet thereon so as to cover the exothermic composition, fixing respective water-absorbing sheets with an adhesive force of the exothermic composition in the state where the exothermic composition is held therebetween, removing a sealing part, and punching out into a greater shape than that of an exothermic composition to form a laminate are performed.

In particular, examples of the water-absorbing sheet in the step (A) include those described above. Since the water-absorbing sheet absorbs water by lamination of an exothermic composition, the strength thereof is lowered, the sheet is swollen to generate elongation, and positioning at a later step easily becomes unstable, a water-absorbing sheet of a sheet-like non-woven cloth, a paper or the like using both of a hydrophilic fiber and hydrophobic fiber are desirable. Additionally, a rayon non-woven cloth, a non-woven cloth of a pulp fiber and a hydrophobic fiber, a non-woven cloth of a pulp fiber and a rayon fiber, a paper and a water-resistant paper are preferable.

Examples thereof include Pulcloth P-40 (trade name) manufactured by Honshu Kinocloth Co., Ltd., having a basis weight of 40 g/m², a thickness of 0.8 mm and a water-retention of 20-fold.

As a means of removing a sealing part and punching out into a greater shape than that of an exothermic composition after respective water-absorbing sheets are fixed with an adhesive force of an exothermic composition in the state where the aforementioned exothermic composition is held therebetween, the same means as those described above are used. Like this, punching out into a greater shape than that of an exothermic composition is performed for preventing contact of a blade of a cutter with an exothermic composition, and preventing abrasion and erosion of a blade, whereby, the durability of the cutter is remarkably improved and falling of an exothermic composition can be prevented.

In this case, an exothermic composition plays the same role as that of an adhesive, and two water-absorbing sheets are applied with an adhesive force of an exothermic composition.

In the present process, a step (C) of holding this laminate between a substrate and a covering material and thermally fusing or thermally adhering a part for sealing the covering material and the substrate is performed in parallel with the aforementioned steps (A) and (B).

Examples of a substrate and a covering material in this step (C) include the same materials as those described above.

In the present process, the present heater element which produces the heat by contact with air is obtained and, therefore, at least one of or a part of the aforementioned substrate and covering material has the breathability.

The present process comprises the aforementioned steps (A)-(C), that is, it is one of processes for suitably manufacturing the present heater element. Since a water-absorbing sheet is arranged on both sides, the ability to absorb excess moisture in an exothermic composition and remove a barrier layer can be enhanced. Since air is easily supplied through a water-absorbing sheet on both sides, rise in a temperature at use initiation is more rapidly heightened and, moreover, the soft feeling is much improved by double water-absorbing sheets, the flexibility becomes rich, a heat production temperature is stable and excess heating can be preventing and thus, there are advantages of extremely improving the safety. Further, since a means of punching out into a desired shape after two water-absorbing sheets are applied via an exothermic composition is adopted, deviation at manufacturing and leakage of an exothermic composition can be extremely inhibited. By rapidly punching out into an arbitrary shape using a roll cutter or the like, the present heater element having the more excellent quality can be obtained.

### BRIEF EXPLANATION OF THE DRAWING

FIG. 1 is a schematic cross-sectional view of a heater element relating to Example of the present invention.

### EXAMPLES

Examples of the present invention will be specifically explained based on drawings below but the present invention is not limited to them.

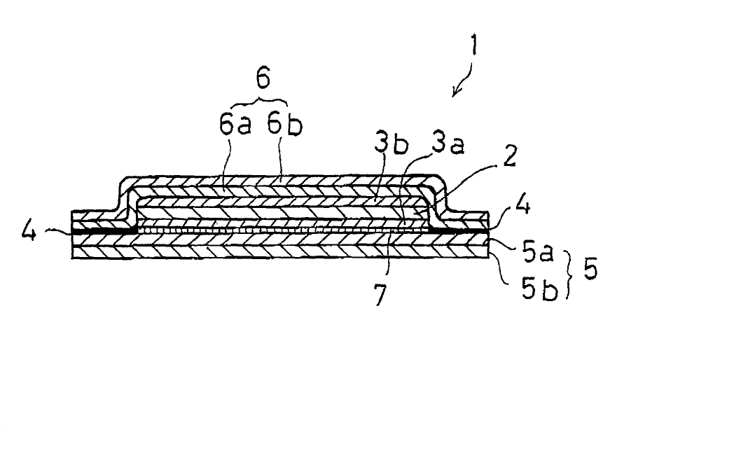

As shown in a schematic cross-sectional view of FIG. 1, the present heater element of this example has the following structure: a laminate in which a flowing exothermic composition 2 is held between a water-absorbing sheet 3a and a water-absorbing sheet 3b, is encapsulated in a sheet-like packaging material 1 in the state where the laminate is positioned and fixed via an adhesive layer 7 in a non-breathable polyethylene film 5a of a substrate 5.

And, in this case, water-absorbing sheets 3a and 3b are formed larger than an exothermic composition 2 so that their circumferential parts are projected 1.5 mm outwardly from an outer circumference of the exothermic composition 2.

The substrate 5 in which a non-breathable polyethylene film 5a having a thickness of 25 μm is laminated on an outer side of a non-woven cloth 5a (thickness 0.50 mm, Soflon E P-40 manufactured by Unitech K.K., 40 g/m²) of 100% polyester, was used in order to obtain the sufficient flexibility.

In addition, in order to enhance the mechanical strength and obtain the sufficient flexibility, the covering material 6 was used in which a non-woven 6b (thickness 0.74 mm, EW-7180 manufactured by Nippon Vilene Co., Ltd. 80 g/m²) of 100% polyester was laminated on an outer side of a perforated film 6a obtained by treating a polyethylene film having a thickness of 25 μm with a thin needle (diameter 0.8 mm) perforation (54/10 mm perforation interval). The final breathability of this covering material 6 was adjusted to around 20 seconds/100 ml with a Gurley-type densometer.

Further, the aforementioned water-absorbing sheet 3 contacts with a flowing exothermic composition 2 and absorbs a part of its moisture. As this water-absorbing sheet 3, a polymer sheet [(paper 18 g/m²)/(water-absorbing polymer 12 g/m²)/(paper 18 g/m²)] having a water-absorbing rate of about 10-fold own weight was used. The sheet was formed by punching out into a shape of a rectangle (longitudinal 88 mm, transverse 58 mm), that is, a shape except for a part for sealing the substrate 5 and the covering material 6.

The aforementioned flowing exothermic composition 2 is the present composition and prepared by the following method.

First, 10.0 parts by weight of activated carbon (SA-Super manufactured by Norit Japan Corporation Ltd.) as a carbon component, 4.0 parts by weight of salt (sodium chloride) as a metal chloride, 0.5 part by weight of CMC (trade name Cellogen HH manufactured by Dai-ichi Kogyo Seiyaku Co., Ltd.) as a thickening agent, 3.0 parts by weight of a polyolefin fiber (Chemibest FDSS-5 manufactured by Mitsui Chemicals, Inc.) as a void-forming fiber and 0.2 part by weight of calcium hydroxide as a pH adjusting agent were mixed relative to 100 parts by weight of iron powders (DKP manufactured by Dowateppun) as an exothermic component, and a raw material having an incorporation rate of 45.0 parts by weight of water was weighed.

Powder raw materials except iron powders were placed into a mixer (manufactured by Dalton Corporation, Model 5DMr, volume 5 liter), a rotating number of a blade was fixed at 63 rpm, the materials were mixed for 2 minutes, water was added, which was kneaded for 5 hours. After the materials became viscous, 60 parts by weight of iron powders were added, kneaded for 5 hours, remaining iron powders were added, and kneaded for 5 hours to prepare a flowing exothermic composition.

Thereafter, a blade and attached matters in a container were cleaned, kneading was performed again for 5 hours, the flowability was measured, and moisture adjustment was performed. An amount of water which was finally added was 48.0 parts by weight relative to 100 parts by weight of iron powders (DKP manufactured by Dowateppun).

The flowability of this flowing exothermic composition 2 was 5 kg/cm² as measured by Texture Analyzer.

And, this heater element 1 can be prepared, for example, by the following method.

That is, a flowing exothermic composition 2 was printed using a stencil having a plate thickness of 0.5 mm, laminated on an upper side of a water-absorbing sheet 3a into a shape of a rectangle (longitudinal 85 mm, transverse 55 mm), a water-absorbing sheet 3b was laminated thereon so as to cover the exothermic composition 2, both water-absorbing sheets 3a and 3b were fixed with an adhesive force of a viscous exothermic composition 2, which was punched out into a shape of a rectangle (longitudinal 88 mm, transverse 58 mm) to obtain a laminate.

A hot melt series adhesive was laminated at a width of 50 mm on a polyester non-woven cloth layer 5a of a substrate 5 by a melt blowing format, to form an adhesive layer 7, the laminate was positioned and fixed on the substrate 5 with an adhesive force of this adhesive layer 7 so as not to be present at a sealing part 4 and, then, a substrate 5 and a covering material 6 were laminated, and a part 4 for sealing a polyester non-woven cloth layer 5a of a substrate 5 and a perforated polyethylene film 6a of a covering material 6 was heat-sealed to obtain the present heater element having a sealing width of 7.5 mm.

The present heater element is encapsulated in an air-tight outer packaging material, and is supplied to a market.

And, after the present heater element of the aforementioned Example was encapsulated in an outer packing material and 24 hours passed, the outer packaging material was opened, which was contacted with the body surface (waist part) of human being. When the element was used normally, a heat production temperature was risen to about 38° C. in a short time of around 1 minute and, thereafter, the heat was continuously produced at 38-42° C. over 6 hours. During use, the exothermic composition 2 in the present heater element was not moved at all in the packaging material 1 and, moreover, by covering both sides of the exothermic composition 2 with water-absorbing sheets 3a and 3b, the soft feeling was further improved, the flexibility became rich, the use feeling was further improved, and uniform heat production was recognized over the whole side.

As explained above, the present composition has the aforementioned essential features, that is, is an exothermic composition for forming a heater element by lamination and encapsulation in a packaging material. And, this exothermic composition is controlled by the flowability and, thus, the following particularly remarkable effects are exerted.

That is, the following effects are exerted: the present composition can be laminated rapidly on an upper side of a substrate without the necessity of an excess force upon extrusion through a coater and without burdening a load on a motor. Control of a laminated region can be performed highly precisely and, at the same time, control can be performed at a very thin membrane thickness and uniformly. In the manufacturing step, simple means of transferring and printing techniques such as printing technique and coating can be utilized, quantitation (weighing) can be performed very simply and precisely, the quality of the heater element can be improved.

Additionally, in the present composition, the exothermic composition can be pipe-transported by a pump or the like, and such the effects are exerted that the composition can be laminated directly on a packaging material without contact with air from a raw material tank to a laminating step.

Further, in the present composition, a moisture covers the periphery of iron powders as an exothermic material, a thickness of such the moisture layer becomes a barrier against air, and contact of the interior of the exothermic composition with air is prevented. Therefore, the loss of an exothermic material due to heat production at manufacturing is not present, and such the effects are exerted that deterioration of the quality can be prevented.

In addition, in the present composition, by adopting such the essential features that, after laminated and encapsulated in a packaging material, a barrier moisture in an exothermic composition is moved to a packaging material and/or a water-absorbing sheet provided in the packaging material, continuous voids are formed in the interior of the exothermic composition and, as a result, such the effects are exerted that an exothermic reaction in the interior of the exothermic composition becomes smooth.

In the present composition, by adopting such the essential features that continuous voids are formed in the interior of an exothermic composition, the efficacy of an exothermic reaction can be more remarkably improved and iron powders oxidized by an exothermic reaction can be prevented from joining mutually and, as a result, such the effects are exerted that the flexibility of a heater element is not lost during use or after use, and the flexibility and the use feeling can be improved.

Further, the present composition can be printed using the known transferring and printing techniques such as transference, thick printing, gravure printing, offset printing, screen printing, stencil printing, and spraying, and can be transferred and laminated extremely easily on a substrate by application with a head coater, a roller, an applicator and the like, by impregnation and coating. Moreover, an ultra-thin type heater element can be manufactured rapidly and an exothermic composition can be uniformly distributed on a packaging material. Thus, the foregoing effects can be exerted.

The present heater element comprises the aforementioned present composition laminated and encapsulated in a packaging material, at least a part of which has the breathability. In particular, an aspect in which a water-absorbing sheet is provided so as to cover an exothermic composition layer except for a part for sealing a substrate and a covering material makes complete heat sealing between the covering material and the substrate. Additionally, by removing a barrier layer by absorption of a barrier moisture in an exothermic composition by a water-absorbing sheet, rise in a temperature at use initiation is rapidly heightened and the sealing strength of a sealing part and the sealing property of a sealing part are heightened, whereby, the effects of preventing bleeding out of iron ions are exerted. Additionally, by adopting such the essential features, since it is not necessary to use a hydrophilic water-absorbing sheet as a substrate and/or a covering material which is a packaging material, such the effects are exerted that even hot melt adhesion can improve the sealing strength and the sealing property considerably.

Further, since the present heater element is a thin-type sheet-like heater element and, moreover, the soft feeling is further improved by a water-absorbing sheet, the element is rich in the flexibility, a heat production temperature is stable and excess heating can be prevented, burn at a low temperature can be prevented assuredly and, as a result, such the effects are exerted that the safety is extremely improved.

That is, since the present heater element uses the aforementioned present composition, it can be extremely easily transferred and laminated evenly on a substrate and a thin-type heater element can be manufactured rapidly and, moreover, an exothermic composition is not biased during use, a temperature is stable in the whole heater element and, therefore, such the effects are exerted that the element is extremely safe and the quality is stabilized.

And, in the present heater element, the aforementioned water-absorbing sheet is provided so as to cover an exothermic composition layer except for a part for sealing a substrate and a covering material, whereby, complete heat sealing between a covering material with hydrophobic and thermally fusion bonding and a substrate becomes possible and, as a result, by heightening the sealing strength of a sealing part and the sealing property of a sealing part, bleeding out of iron ions can be prevented. Additionally, since by adopting such the essential features, it is not necessary to use by laminating a hydrophilic water-absorbing sheet as a substrate and/or a covering material which is a packaging material, even hot melt adhesion (thermal adhesion) can improve the sealing strength and the sealing property considerably. Further, by removing a barrier layer by absorption of an excess moisture in a viscous exothermic composition by a water-absorbing sheet, such the effects are exerted that rise in a temperature at use initiation is rapidly heightened.

In particular, in the present heater element, the loss of an exothermic composition is not present in any shape. Additionally, since a packaging material (substrate, covering material) and a water-absorbing sheet are separate members, multi-layer of a packaging material is avoided as much as possible and a single layer part is increased, whereby, the low cost and recycling of tailing after punching become possible. Alternatively, a simple structure is possible in which a non-water-absorbing sheet and a water-absorbing sheet (covering an exothermic composition and not via a sealing part) are overlapped, whereby, the element can be separated and segregated into a recyclable structure after punching, and the flexibility can be increased and, moreover, defects of delayed initial heat production rate, which are defects of a heater element comprising a viscous exothermic composition, are dissolved. Thus, the foregoing effects are exerted.

Further, in the present heater element, in the case where a lamination pattern for an exothermic composition is large, when the pattern is divided into some patterns, which are grouped and unified to laminate one water-absorbing sheet, a step can be simplified, and a part on which no exothermic composition is laminated is easily bent, whereby, the flexibility of a heater element is remarkably improved. As a result, such the effects are exerted that the soft feeling and the use feeling are remarkably improved.

Further, in the present process, by providing a water-absorbing sheet having great heat storing property and adiabatic property outside a heater element, an effective heater element which can extremely prevent radiation of the heat towards an upper side (outside) and which hardly receives effects of an outer air temperature can be obtained.

Additionally, in the present process, by laminating a water-absorbing sheet on both sides of a flowing exothermic composition, the ability to absorb a moisture in an exothermic composition is further heightened, and a barrier layer is assuredly removed, and air is supplied from both sides, whereby, rise in a temperature at use initiation can be further rapidly heightened assuredly. Moreover, double water-absorbing sheets improve the soft feeling much, the composition becomes rich in the flexibility, and the use feeling is extremely improved and, moreover, a heat production temperature is safe and excess heating can be prevented, whereby such the effects are exerted that the safety is extremely improved.

In the present process, by adopting such the essential features that respective water-absorbing sheets are laminated on both sides of a flowing exothermic composition, which is punched out into a greater shape than that of the aforementioned exothermic composition and, thereafter, this laminate is present between a substrate and a covering material, and an outer circumferential part of the laminate is thermally fused or thermally adhered, a blade of a cutter does not contact with an exothermic composition upon formation of a laminate and, therefore, breakage of a blade and corrosion of a blade do not occur and, as a result, the durability of a cutter can be remarkably improved and at the same time falling of an exothermic composition can be prevented.

Further, in the present process, when such the essential features are adopted, since a means of punching out into a predetermined shape after two water-absorbing sheets are applied together via an exothermic composition, deviation at manufacturing and leakage of an exothermic composition can be extremely prevented. Moreover, rapid punching out into an arbitrary shape is possible using a roll cutter or the like while avoiding an exothermic composition layer and, as a result, such the effects are exerted that a manufacturing step can be further simplified and, at the same time, a manufacturing time can be shortened.

What is claimed is:

1. A flowing exothermic composition, comprising an exothermic composition for forming a heater element by lamination and encapsulation in a packaging material, wherein the exothermic composition has the plastic flowability and is controlled by the flowability.

2. The flowing exothermic composition according to claim 1, wherein the flowability is in a range of 0.5 to 20 kg/cm² at a temperature of 20° C.

3. The flowing exothermic composition according to claim 1 or 2, wherein, after the flowing exothermic composition is laminated and encapsulated in a packaging material, the moisture in the flowing exothermic composition as a barrier is moved to a water-absorbing sheet, and whereby continuous voids are formed in the interior of said flowing exothermic composition.

4. The flowing exothermic composition according to any one of claims 1 to 3, wherein a void-forming fiber is contained in the flowing exothermic composition.

5. The flowing exothermic composition according to claim 4, wherein the void-forming fiber is a hydrophobic void-forming fiber.

6. A heater element, wherein the flowing exothermic composition according to any one of claims 1 to 5 is laminated and encapsulated in a packaging material, at least a part of the packaging material having the breathability.

7. The heater element according to claim 6, wherein a breathable water-absorbing sheet covers one side or both sides of the flowing exothermic composition.

8. The heater element according to claim 7, a breathable water-absorbing sheet is laminated so as not to exist in a sealing part.

9. The heater element according to claim 7 or 8, wherein the water-absorbing sheet is formed by inclusion of a water-absorbing agent in a water-absorbing support.

10. A process for manufacturing a heater element, which comprises patterning and laminating the flowing exothermic composition according to any one of claims 1 to 5 on a sheet-like water-absorbing sheet having the breathability, further laminating another water-absorbing sheet thereon so as to cover the exothermic composition, fixing respective water-absorbing sheets with the adhering force of the exothermic composition in the state where the exothermic composition is held therebetween, which is punched except for a sealing part into a greater shape than that of an exothermic composition to form a laminate, and then holding this laminate between a substrate and a covering material to thermally fusion bond or thermally adhere a sealing part between the covering material and the substrate.
